(19) United States
(12) Patent Application Publication
(10) Pub. No.: US 2012/0256780 A1
(43) Pub. Date: Oct. 11, 2012

(54) RADAR EQUIPMENT AND RECEIVED DATA PROCESSING METHOD

(76) Inventor: Yoshikazu Shoji, Kawasaki-shi (JP)

(21) Appl. No.: 13/439,100

(22) Filed: Apr. 4, 2012

(30) Foreign Application Priority Data
Apr. 6, 2011 (JP) 2011-084208

(51) Int. Cl. G01S 13/18; G01S 13/58

(52) U.S. Cl. 342/101; 342/107

(57) ABSTRACT

According to one embodiment, a radar equipment includes a radio transmitter, a pulse compressor, a Doppler filter, and an integration processor. The radio transmitter receives pulse signals and digitizes the received pulse signals by oversampling with a frequency higher than that for generation of a pulse compression coefficient to generate digital data. The pulse compressor performs pulse compression on the digital data using the pulse compression coefficient to generate range bin data for each of the pulse signals. The Doppler filter processor performs Doppler filter processing on the range bin data. The integration processor integrates the range bin data subjected to the Doppler filter processing for each range bin.

### CROSS-REFERENCE TO RELATED APPLICATIONS

This application is based upon and claims the benefit of priority from prior Japanese Patent Application No. 2011-084208, filed Apr. 6, 2011, the entire contents of which are incorporated herein by reference.

### FIELD

Embodiments described herein relate generally to a radar equipment and a received data processing method.

### BACKGROUND

A radar equipment configured to integrate signals obtained by scans to achieve greater target detection accuracy has been known. The radar equipment receives pulse signals, which are transmitted at predetermined pulse repetition interval (PRI) as a plurality of transmission pulses and reflected, scattered, or diffracted. The radar equipment performs pulse compression on the received pulse signals, and performs Doppler filter processing on the signals subjected to the pulse compression. The radar equipment integrates the signals subjected to the Doppler filter processing between scans, and measure the signal strength. When the measured signal strength exceeds a predetermined threshold, the radar equipment detects the signal as a target signal.

When a signal subjected to Doppler filter processing is integrated with a signal obtained by the next scan, the radar equipment estimates a degree of movement of a target between scans, and estimates a signal obtained by the next scan. The radar equipment integrates the estimated signal with a signal obtained by the next scan. However, if there is an error between the estimated degree of movement and the actual degree of movement, signals obtained by scans cannot be correctly integrated.

### BRIEF DESCRIPTION OF THE DRAWINGS

FIG. 1 is a block diagram showing a functional configuration of a radar equipment according to a first embodiment.

FIG. 2 shows a functional configuration of the pulse compressor shown in FIG. 1.

FIG. 3 shows pulse compression processing performed by the pulse compressor shown in FIG. 1.

FIG. 4 shows Doppler filter processing performed by the Doppler filter processor shown in FIG. 1.

FIG. 5 shows a functional configuration of the integration processor shown in FIG. 1.

FIG. 6 is an image of sampling after pulse compression processing of the case where the sampling frequency for generating a pulse compression coefficient is the same as that for digital conversion.

FIG. 7 is an image of sampling after pulse compression processing of the case where digital conversion is performed with an oversampling frequency.

FIG. 8 shows an example of range bin data for each frequency bin obtained based on a received pulse received at the radar equipment shown in FIG. 1.

FIG. 9 shows integration processing performed by the integration module shown in FIG. 5.

FIG. 10 shows parameters used in a simulation for the radar equipment shown in FIG. 1.

FIG. 11 shows detection probabilities obtained as a result of the simulation based on the parameters shown in FIG. 10.

FIG. 12 shows integration processing of the case where there is an error between the number of range bins estimated by the radar equipment and the actual number of range bins by which a target moves.

FIG. 13 shows a functional configuration of the integration processor shown in FIG. 1.

FIG. 14 shows an example of arrangement of radar equipments each including the integration processor shown in FIG. 13.

FIG. 15 shows another functional configuration of the radar equipment shown in FIG. 1.

FIG. 16 shows an example of interpolation processing performed by the interpolation processor shown in FIG. 15.

FIG. 17 is a block diagram showing a functional configuration of a radar equipment according to a second embodiment.

FIG. 18 is a block diagram showing a functional configuration of the multiplication processor shown in FIG. 17.

FIG. 19 is a block diagram showing a functional configuration of the multiplication processor shown in FIG. 17.

FIG. 20 shows another functional configuration of the radar equipment shown in FIG. 17.

### DETAILED DESCRIPTION

In general, according to one embodiment, a radar equipment includes a radio transmitter, a pulse compressor, a Doppler filter, and an integration processor. The radio transmitter receives pulse signals and digitizes the received pulse signals by oversampling with a frequency higher than that for generation of a pulse compression coefficient to generate digital data. The pulse compressor performs pulse compression on the digital data using the pulse compression coefficient to generate range bin data with an increased number of samples for each of the pulse signals. The Doppler filter processor performs Doppler filter processing on the range bin data to generate range bin data with an increased number of samples for each frequency bin. The integration processor integrates the range bin data subjected to the Doppler filter processing for each range bin.

### First Embodiment

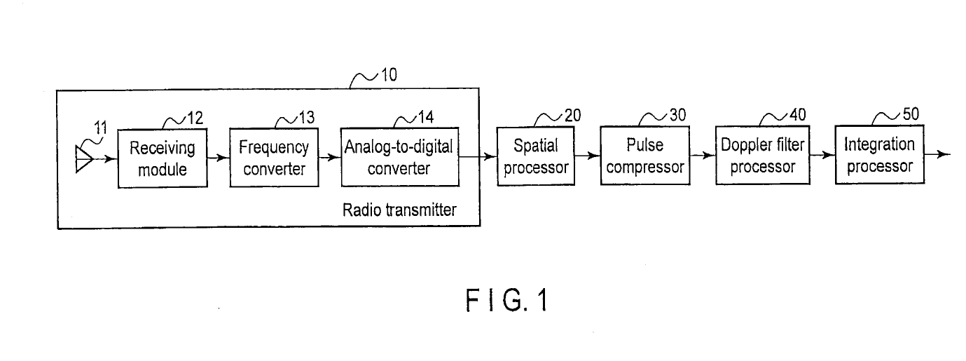

FIG. 1 is a block diagram showing a functional configuration of a radar equipment according to a first embodiment. The radar equipment shown in FIG. 1 comprises a radio transmitter 10, a spatial processor 20, a pulse compressor 30, a Doppler filter processor 40, and an integration processor 50.

The radio transmitter 10 comprises an antenna element 11, a receiving module 12, a frequency converter 13, and an analog-to-digital-converter 14. The antenna element 11 receives pulse signals, which are transmitted at predetermined pulse repetition interval (PRI) as a plurality of transmission pulses and reflected, scattered, or diffracted. The antenna element 11 outputs each received pulse to the receiving module 12.

The receiving module 12 amplifies the power of the received pulse supplied from the antenna element 11.

The frequency converter 13 converts the received pulse amplified at the receiving module 12 into a pulse in a base band.

The analog-to-digital converter 14 digitizes the received pulse supplied from the frequency converter 13, and outputs the digitized received pulse to the spatial processor 20. The sampling frequency for the digital conversion is higher than that for generation of a pulse compression coefficient at the pulse compressor 30. Namely, the analog-to-digital converter 14 digitizes a pulse signal by using oversampling.

The spatial processor 20 applies a predetermined beam weight on the received pulse digitized at the radio transmitter 10 to form a reception beam.

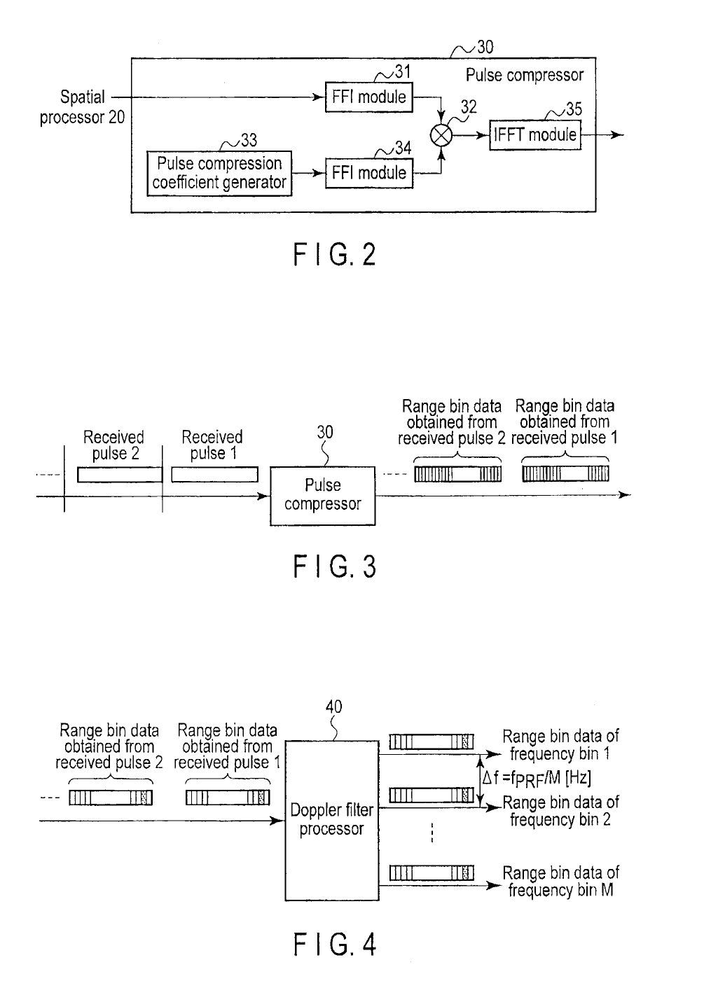

FIG. 2 shows a functional configuration of the pulse compressor 30 of the radar equipment according to the first embodiment. The pulse compressor 30 comprises fast Fourier transform (FFT) module 31, a mixer 32, a coefficient generator 33, FFT module 34, and an inverse fast Fourier transform (IFFT) module 35.

FFT module 31 performs an FFT on the received pulse supplied from the spatial processor 20, and outputs the resultant signal to the mixer 32. The coefficient generator 33 generates a pulse compression coefficient with a predetermined sampling frequency, and outputs the generated pulse compression coefficient to FFT module 34. FFT module 34 performs an FFT on the generated pulse compression coefficient, and outputs the resultant signal to the mixer 32.

The mixer 32 multiplies signals supplied from the FFT modules 31, 34, and outputs the resultant signal to the IFFT module 35. The IFFT module 35 performs an IFFT on the signal supplied from the mixer 32, and outputs the resultant signal to the Doppler filter processor 40. In this manner, the pulse compressor 30 performs pulse compression processing on the digital data with samples increased in number because of oversampling in digital conversion. By the pulse compression processing, range bin data for each received pulse is generated.

The pulse compressor 30 outputs the generated range bin data to the Doppler filter processor 40. FIG. 3 is a schematic diagram of pulse compression processing performed by the pulse compressor 30.

The Doppler filter processor 40 performs an FFT on range bin data of each received pulse supplied from the pulse compressor 30, and generates range bin data for each frequency bin. FIG. 4 is a schematic diagram of Doppler filter processing performed by the Doppler filter processor 40.

The integration processor 50 generates processing data (to be described later) based on the range bin data supplied from the Doppler filter processor 40, and integrates the generated processing data.

Described below are configuration examples of the integration processor 50 of the radar equipment according to the first embodiment.

### Example 1

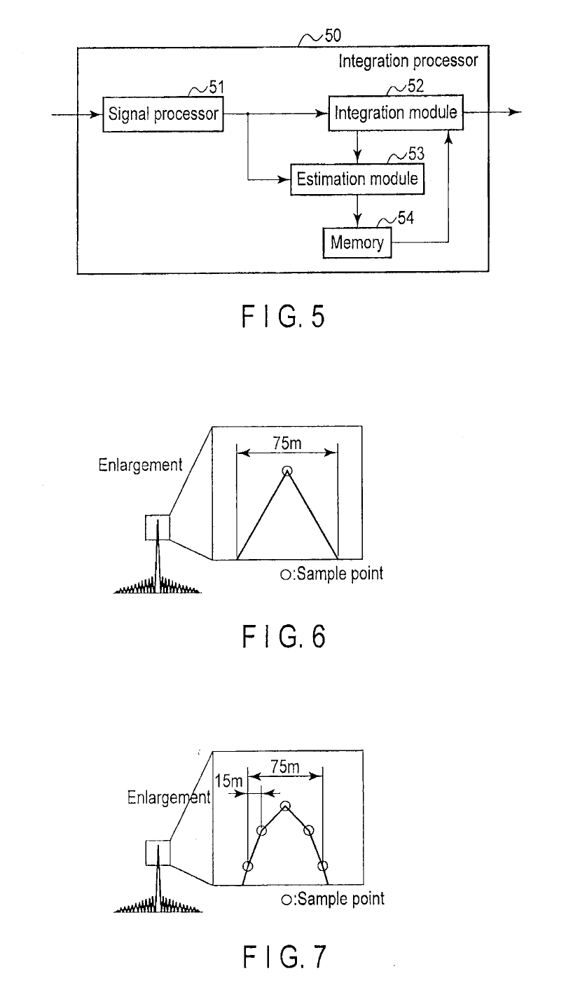

FIG. 5 is a block diagram showing a functional configuration of the integration processor 50 of the radar equipment in Example 1 of the first embodiment.

In Example 1, the sampling frequency with which the coefficient generator 33 generates a pulse compression coefficient is 2 MHz, and the sampling frequency with which the analog-to-digital converter 14 digitizes a received pulse is 10 MHz. Generally, the sampling frequency with which a pulse compression coefficient is generated is the same as that with which a received pulse is digitized. Sampling shown in FIG. 6 is performed after pulse compression processing in the case where the sampling frequency with which a pulse compression coefficient is generated is the same as that with which a received pulse is digitized. Sampling shown in FIG. 7 is performed after pulse compression processing in the case where a received pulse is digitized with an oversampling frequency. In this case, the number of samples is five times greater than in the case where the sampling frequencies are the same. In FIG. 7, the target signal gain of each sample is greater than approximately −3 dB from the peak value of pulse compression.

The following parameters are given to the radar equipment according to the first embodiment: the pulse repetition frequency (PRF) is 1000 Hz; the number of pulses is 32; one range resolution is 75 m; and the sampling frequency of the analog-to-digital converter 14 is 10 MHz.

The integration processor 50 shown in FIG. 5 comprises a signal processor 51, an integration module 52, an estimation module 53 and a memory 54. The signal processor 51 makes the status of a predetermined search area expressed by range r, azimuth θ, elevation angle φ, and relative velocity vₘ based on the range bin data supplied from the Doppler filter processor 40. Namely, the signal processor 51 generates first four-parameter data so that the amplitude values of all range bin data obtained by one omnidirectional scan can be identified by range r, azimuth θ, elevation angle φ, and relative velocity vₘ. First four-parameter data obtained by scan i is expressed by R⁽ⁱ⁾(r, θ, φ, vₘ). The signal processor 51 outputs the first four-parameter data to the integration module 52.

The relative velocity vₘ of a target in the mth frequency bin (where m is a natural number from 1 to M) is obtained as described below. The frequency bandwidth Δf of each frequency bin shown in FIG. 4 is expressed as Δf=f_{PRF}/M, where M represents the number of pulses transmitted during a coherent processing interval (CPI). f_{PRF} is 1/T_{PRI}, where T_{PRI} represents a pulse repetition interval. Assuming that the value of each frequency bin varies only depending on change in the Doppler frequency caused by movement of the target, the relative velocity vₘ(m) in the mth frequency bin is expressed by vₘ(m)=m·Δf·c/fc, where c represents the light speed, and fc represents a carrier frequency.

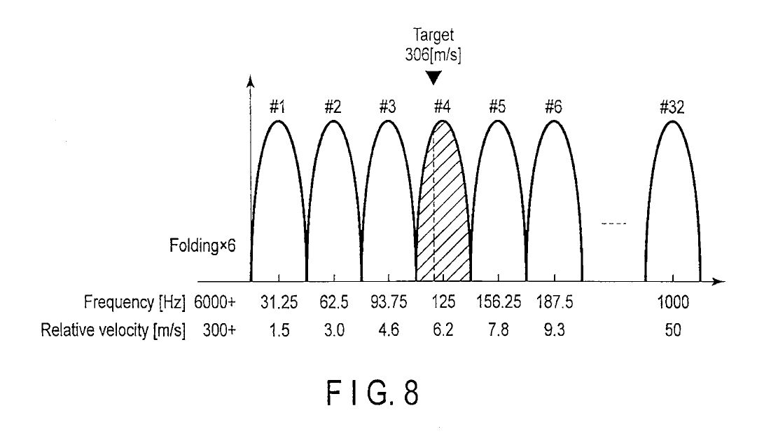

For example, when range bin data is obtained at the 196^{th} frequency bin (including six foldings) as shown in FIG. 8, the signal processor 51 calculates that the relative velocity of the target is 306.2 m/s.

When the estimation module 53 receives third four-parameter data (to be described later) from the signal processor 51, the estimation module 53 assumes that a target is present in all the elements of third four-parameter data. The estimation module 53 estimates a range bin in which the target would be present when a next scan is performed, on the basis of the relative velocity, which is a parameter of the third four-parameter data. The range bin is each of search area divisions having a predetermined range. The processing at the estimation module 53 will be described below.

The radar equipment in Example 1 receives reflected waves of transmission pulses sequentially emitted in all directions in a predetermined search area. Namely, a pulse signal is received discretely (at scan intervals) from the same direction. When a scan is performed every T_{scan} seconds, range bin data of each frequency bin 1-M shown in FIG. 4 is obtained every T_{scan} seconds.

When it is assumed that a target moves with uniform linear motion, a target present in frequency bin m is estimated to be at a distance of vₘ(m)·T_{scan} at the time of the next scan which is performed T_{scan} seconds later. For example, when scan period T_{scan} is 8.64 s, the number of range bins by which a target moves during one scan is calculated to be 35.2512 using the above-given relative velocity of 306.2 m/s and one range resolution of 75 m. Therefore, the number of range bins by which the target moves is estimated to be 35. Because of oversampling in digital conversion, each range bin is smaller than in the case where oversampling is not used. In Example 1, the number of samples is five times larger. Therefore, the number of range bins by which the target moves is estimated to be 175. Accordingly, when a target is present in range bin r, frequency bin m at the time of the i^{th} scan, the target is estimated to be present in range bin r+175 and frequency bin m at the time of the (i+1)^{th} scan, which is performed T_{scan} seconds later.

The estimation module 53 shifts third four-parameter data to the estimated range bin to generate second four-parameter data. The estimation module 53 causes the memory 54 to store the generated second four-parameter data.

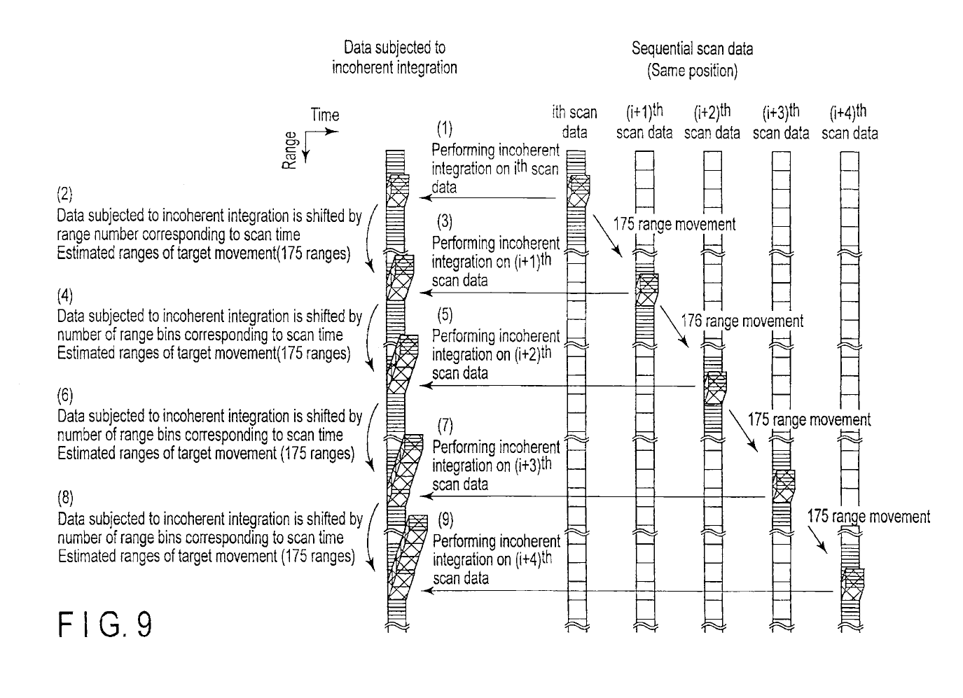

Upon receipt of first four-parameter data from the signal processor 51, the integration module 52 reads second four-parameter data generated based on the previous scan from the memory 54. The integration module 52 performs incoherent integration for combining the amplitude value of the first four-parameter data supplied from the signal processor 51 with the amplitude value of the second four-parameter data read from the memory 54 to generate third four-parameter data. FIG. 9 is a schematic diagram of integration processing performed by the integration module 52. The integration module 52 outputs the generated third four-parameter data to the estimation module 53.

In the case of first scan, the integration module 52 may output the first four-parameter data supplied from the signal processor 51 to the estimation module 53 as third four-parameter data. Further, in the case of first scan, the signal processor 51 may output the first four-parameter data to the estimation module 53. In this case, the estimation module 53 generates second four-parameter data based on the first four-parameter data output from the signal processor 51, and causes the memory 54 to store the generated second four-parameter data.

In addition, the radar equipment may further comprise a target detector in the stage subsequent to the integration processor 50, although it is not shown in FIG. 1. The target detector receives third four-parameter data from the integration processor 50, and determines whether the amplitude value of the received third four-parameter data exceeds a threshold value. The threshold value varies depending on the number of incoherent integration operations at the integration module 52. When the amplitude value of third four-parameter data exceeds the threshold, the target detector determines that a target has been detected.

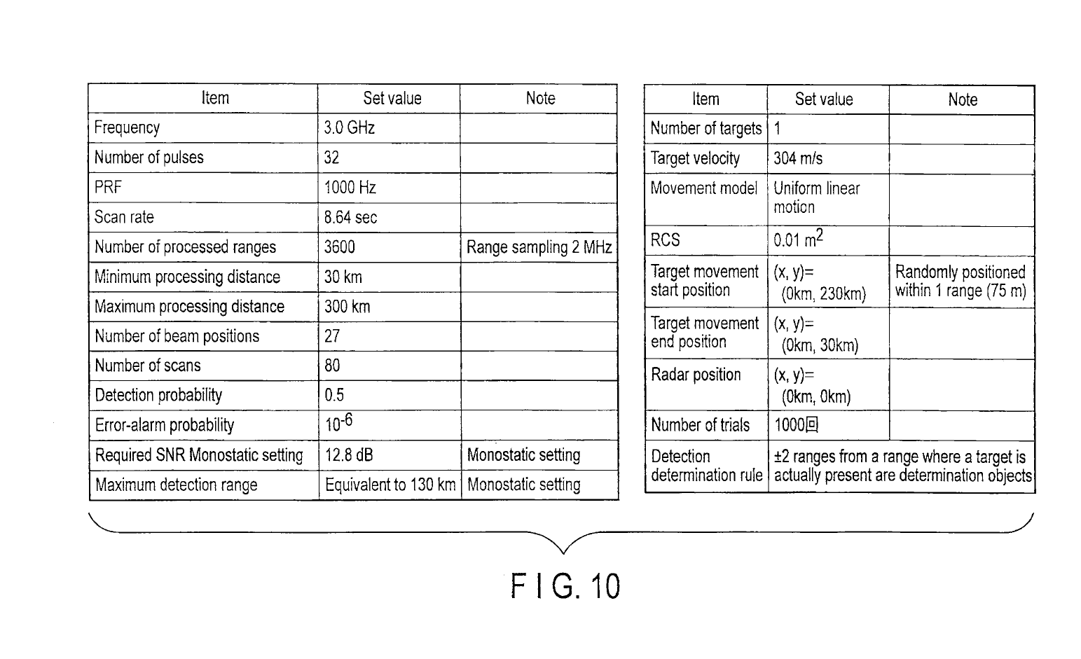

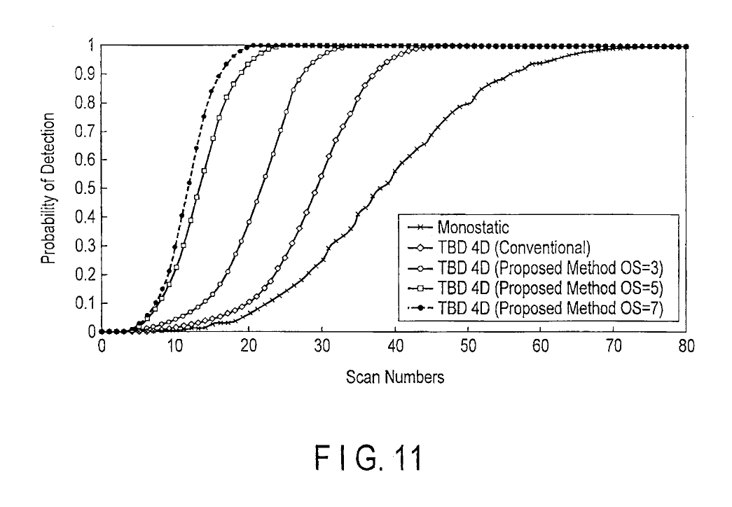

Next, a simulation result of change in the detection probability of the radar equipment having the above-described configuration will be described. FIG. 10 shows parameters used in a simulation for the radar equipment in Example 1. FIG. 11 shows a simulation result of change in the detection probability calculated using the parameters shown in FIG. 10. In FIG. 11, the vertical axis indicates detection probabilities, and the horizontal axis indicates scan numbers. A target moves to the radar equipment, and the distance between the target and the radar equipment decreases as the scan number increases. Namely, the received SNR increases as the scan number increases.

In FIG. 11, the filled circles, squares, and open circles indicate detection probabilities of the cases where the sampling frequency for digital conversion is respectively seven, five and three times higher than that for generation of a pulse compression coefficient at the pulse compressor 30. The diamonds indicate detection probabilities of the case where the sampling frequency for digital conversion is the same as that for generation of a pulse compression coefficient at the pulse compressor 30. The crosses indicate detection probabilities of the case where first four-parameter data is integrated without estimation processing at the integration processor 50. As shown in FIG. 11, when the oversampling number is large, a target can be detected in a scan of a small number. This is because, even when there is an error in the estimated degree of movement of the target, which is estimated at the estimation module 53, the oversampled target signal has large values over several ranges, the estimation error can be tolerated. As a result, high integration gain can be achieved as shown in FIG. 11.

As explained above, in Example 1 of the first embodiment, the analog-to-digital converter 14 digitizes a received pulse with a sampling frequency higher than that for generation of a pulse compression coefficient at the pulse compressor 30. The range resolution is the same as that in the case where oversampling is not used, but the number of samples in the range resolution increases by the number of samples obtained by oversampling. Generally, among a plurality of samples obtained by oversampling, the samples of the highest gains are often selected to compensate for a peak loss. However, in this proposed method, the samples obtained by oversampling are all treated as received data.

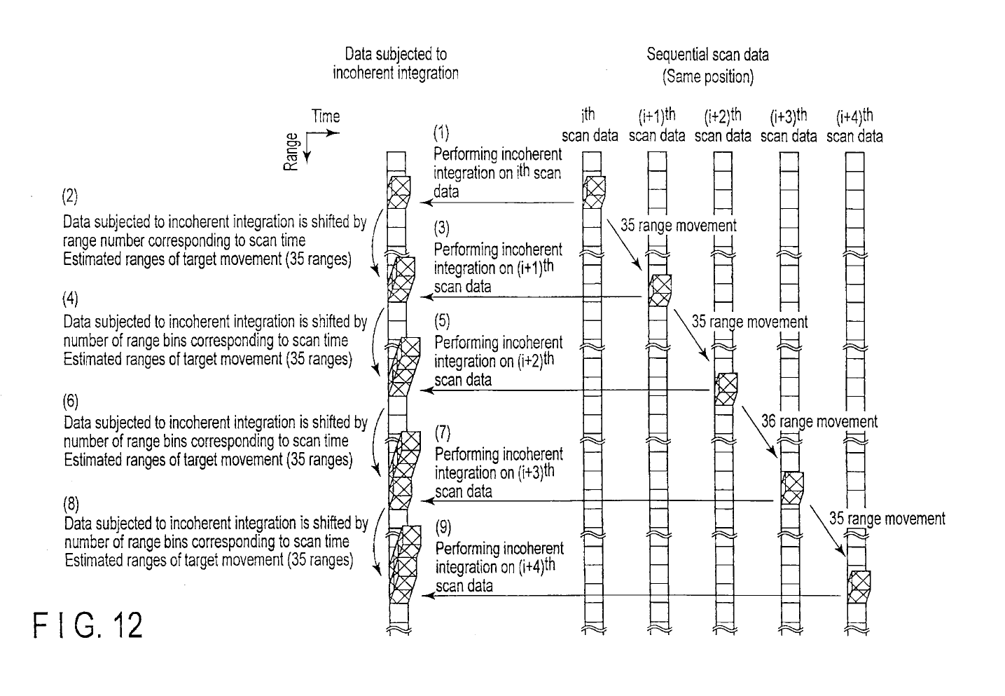

Assuming that a target moves in uniform linear motion, the estimated number of range bins by which a target would move during one scan is usually a fixed whole number. However, in actuality, even when a target moves in uniform linear motion, the number of range bins by which a target moves during one scan is not always fixed because of a non-stationary factor at the radar equipment or the target. Further, the degree of movement of a target involves a fraction. Because of those factors, it is very likely that the number of range bins estimated by the radar equipment (hereinafter referred to as the estimated number of range bins) differs from the actual number of ranges bins by which the target moves (hereinafter referred to as the actual number of range bins). Namely, an error within one range between the estimated number of range bins and the actual number of range bins is very likely to be produced every multiple scans. FIG. 12 shows integration processing performed by the integration processor 50 in the case where there is an error between the number of range bins estimated by the radar equipment and the actual number of range bins by which a target moves. According to FIG. 12, the actual number of ranges bins by which a target moves between the (i+2)^{th} scan and the (i+3)^{th} scan is 36, whereas the estimated number of range bins is 35. Namely, there is an error between the estimated number of range bins and the actual number of range bins. Because of this error, after the (i+3)^{th} scan, the first four-parameter data supplied from the signal processor 51 is not integrated with the second four-parameter data read from the memory 54 in the correct range, and the target detection performance is degraded.

In contrast, in the radar equipment of Example 1, the number of samples is increased as shown in FIG. 7, and target signal components spread over a plurality of range bins, as shown in FIG. 9. Therefore, even when there is an error between the estimated number of range bins and the actual number of range bins, the amplitude value of the second four-parameter value read from the memory 54 is piled up on the amplitude value of the first four-parameter data supplied from the signal processor 51 in at least one range bin. Accordingly, the influence of the error between the estimated number of range bins and the actual number of range bins exerted on integration processing can be mitigated.

### Example 2

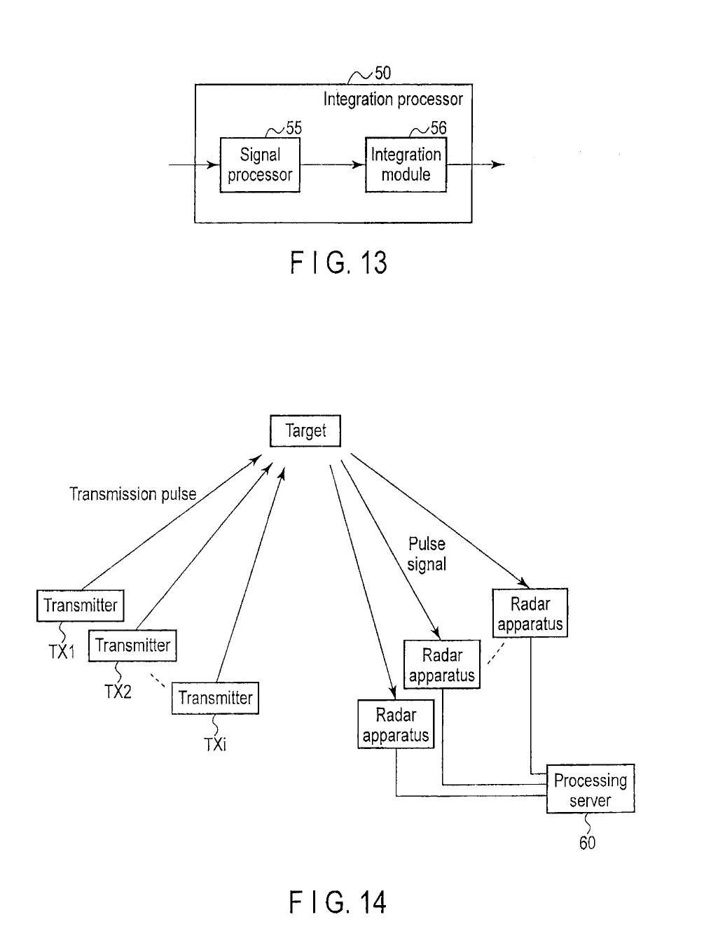

FIG. 13 is a block diagram showing a functional configuration of the integration processor 50 of the radar equipment in Example 2 of the first embodiment. In Example 2, a plurality of radar equipments are provided as shown in FIG. 14. Each radar equipment receives pulse signals, which are transmitted from transmitters TX1-TXR as transmission pulses and, for example, reflected by a target. The transmission pulses transmitted from the transmitters TX1-TXR are pulses modulated to be uncorrelated to each other. The radar equipments share the origin and orthogonal axes of coordinates. The integration processor 50 shown in FIG. 13 comprises a signal processor 55 and an integration module 56.

The signal processor 55 records the origin and orthogonal axes of coordinates. The signal processor 55 keeps the positional coordinates of the radar equipment including the signal processor 55. The signal processor 55 makes the status of a predetermined search area expressed by the x-, y-, and z-positional coordinates of a target and the magnitudes of the x-, y-, and z-directional components of the velocity of the target, based on range bin data supplied from the Doppler filter processor 40. Namely, the signal processor 55 generates six-parameter data F (x, y, z, vₓ, v_{y}, v_{z}) so that the amplitude values of range bin data can be identified by the x-, y-, and z-positional coordinates of a target and the magnitudes of the x-, y-, and z-directional components of the velocity of the target. The signal processor 55 outputs the six-parameter data to the integration module 56.

The integration module 56 performs multiple-input single-output (MISO) integration on the six-parameter data supplied from the signal processor 55. The MISO integration is processing of integrating six-parameter data of pulse signals based on a plurality of transmission pulses. The pulse signals are transmission pulses reflected, scattered, or diffracted by the same target. The MISO integration of six-parameter data will be described below.

The transmitters TX1-TXR direct a transmission beam to a target at different times. Therefore, the pulse signals corresponding to the transmission pulses transmitted from the transmitters TX1-TXR are received by a radar equipment at different times. Further, since the transmitters TX1-TXR direct a transmission beam to a target at different times, the target may move between the times. Therefore, the six-parameter data obtained based on the pulse signals from the same target varies from one transmission source to another.

The integration module 56 predetermines a movement model of a target, and estimates a degree of movement of the target from the time when one transmitter directs a transmission beam to the target to the time when another transmitter directs a transmission beam to the target, based on the predetermined movement model. For example, assuming that the movement model of a target is uniform linear motion, when six-parameter data of a time is F (x, y, z, vₓ, v_{y}, v_{z}), six-parameter data of Δt seconds later is estimated to be F (x+vₓΔt, y+v_{y}Δt, z+v_{z}Δt, vₓ, v_{y}, v_{z}).

Based on the difference between signal receipt times and predetermined movement model, the integration module 56 estimates six-parameter data of a later receipt time from six-parameter data obtained based on a pulse signal received earlier. The integration module 56 integrates the amplitude value of the six-parameter data obtained based on the pulse signal received later with the amplitude value of the estimated six-parameter data. Accordingly, the receipt times of the pulse signals, which are transmitted from the transmitters TX1-TXR as transmission pulses and reflected by the same target, are different from each other, but the integration module 56 can integrate amplitude values of six-parameter data of different transmission sources.

The integration processor 50 outputs the result of the MISO integration to a processing server 60.

The processing server 60 performs single-input multiple-output (SIMO) integration on the MISO integration results obtained at the connected radar equipments. The processing server 60 determines that a target is detected when the amplitude value of the result of the SIMO integration exceeds a threshold value set in accordance with the number of integration operations in the SIMO integration.

In Example 2 of the first embodiment, the analog-to-digital converter 14 digitizes a received pulse with a sampling frequency higher than that for generation of a pulse compression coefficient at the pulse compressor 30. Therefore, the number of samples increases, and target signal components spread over a plurality of range bins. Consequently, even if there is an error between the actual degree of movement of a target and the degree of movement estimated according to a movement model, the amplitude value of the six-parameter data based on the pulse signal subsequently received is piled up on the amplitude value of the estimated six-parameter data in at least one range bin.

Therefore, the influence of the error between the actual degree of movement of a target and the degree of movement estimated according to a movement model exerted on integration processing of six-parameter data of different transmission sources can be mitigated.

The radar equipment according to the first embodiment can correctly integrate signals for each range bin.

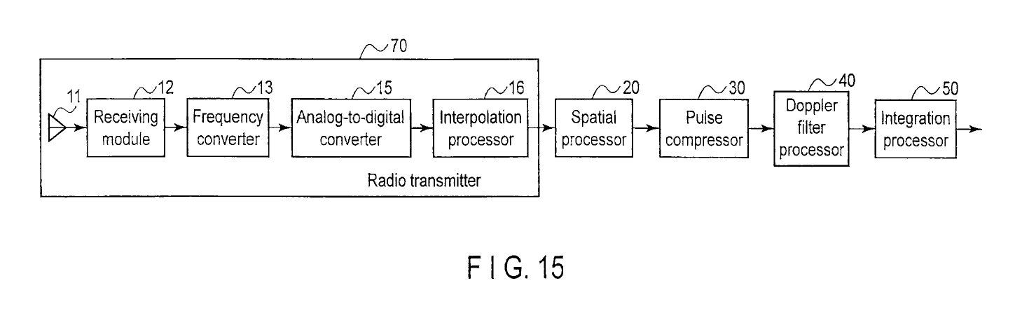

The configuration of the radar equipment of the first embodiment is not limited to the one shown in FIG. 1. For example, the radar equipment may have the functional configuration shown in FIG. 15. The radar equipment shown in FIG. 15 comprises a radio transmitter 70, a spatial processor 20, a pulse compressor 30, a Doppler filter processor 40 and an integration processor 50.

The radio transmitter 70 comprises an antenna element 11, a receiving module 12, a frequency converter 13, an analog-to-digital converter 15 and an interpolation processor 16.

The analog-to-digital converter 15 digitizes a received pulse supplied from the frequency converter 13, and outputs the digitized data to the interpolation processor 16. The sampling frequency for digital conversion is higher than that for generation of a pulse compression coefficient at the pulse compressor 30. Further, those sampling frequencies satisfy the Nyquist theorem. For example, when the sampling frequency for generation of a pulse compression coefficient is 2 MHz, the sampling frequency for digital conversion is set at 4 MHz or higher.

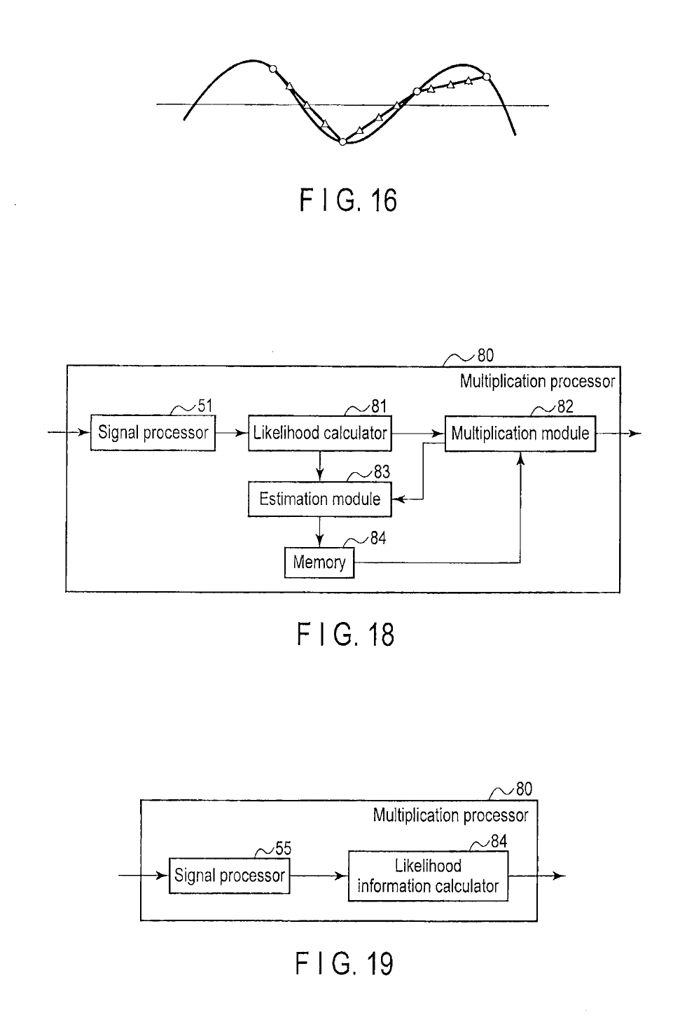

The interpolation processor 16 interpolates the data output by the analog-to-digital converter 15, and generates pseudo-sampling points. For example, the interpolation processor 16 plots a predetermined number of pseudo-sampling points indicated by triangles between adjacent data items indicated by open circles as shown in FIG. 16. The interpolation processor 16 outputs the data with sampling points, the number of which has been increased by interpolation, to the spatial processor 20.

Because of oversampling at the analog-to-digital converter 15 and generation of pseudo-sampling points at the interpolation processor 16, the number of samples in the range resolution increases by the number of samples obtained by oversampling and the number of samples obtained by pseudo-sampling although the range resolution remains the same as that in the case where neither oversampling nor pseudo-sampling is used. Since the number of samples increases, target signal components spread over a plurality of range bins. Therefore, even if there is an error between the actual degree of movement of a target and the degree of movement estimated according to a movement model, amplitude values are piled up in at least one range bin. Accordingly, the influence of the error between the actual degree of movement of a target and the degree of movement estimated according to a movement model exerted on integration processing can be mitigated.

### Second Embodiment

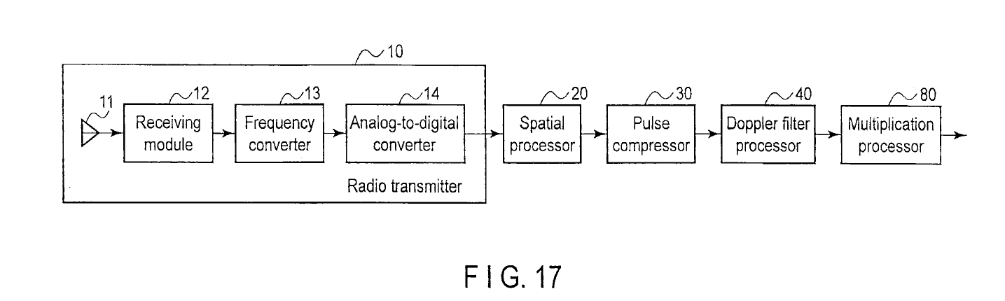

FIG. 17 is a block diagram showing a functional configuration of a radar equipment according to a second embodiment. The radar equipment shown in FIG. 17 comprises a radio transmitter 10, a spatial processor 20, a pulse compressor 30, a Doppler filter processor 40 and a multiplication processor 80.

The radio transmitter 10 comprises an antenna element 11, a receiving module 12, a frequency converter 13, and an analog-to-digital converter 14.

The analog-to-digital converter 14 digitizes a received pulse supplied from the frequency converter 13, and outputs the digitized data to the spatial processor 20. The sampling frequency for digital conversion is higher than that for generation of a pulse compression coefficient generated at the pulse compressor 30. Namely, the analog-to-digital converter 14 digitizes a pulse signal by oversampling.

The multiplication processor 80 calculates likelihood information (to be described later) based on range bin data supplied from the Doppler filter processor 40, and multiplies the calculated likelihood information pieces together.

Described below are configuration examples of the integration processor 80 of the radar equipment according to the second embodiment.

### Example 1

FIG. 18 is a block diagram showing a functional configuration of the multiplication processor 80 of the radar equipment in Example 1 of the second embodiment. The multiplication processor 80 shown in FIG. 18 comprises a signal processor 51, a likelihood calculator 81, a multiplication module 82, an estimation module 83 and a memory 54.

The likelihood calculator 81 compares the distribution of amplitude values indicated by first four-parameter data supplied from the signal processor 51 with a probability density distribution of radar equipment noise stored in advance so as to calculate, as likelihood information, a probability that the received pulse referred to when the first four-parameter data is generated is a noise signal of the radar equipment. The likelihood calculator 81 generates fourth four-parameter data by converting the amplitude value indicated by first four-parameter data into the calculated likelihood information. The likelihood is a probability that the amplitude value indicated by each bin of first four-parameter data is derived from a noise signal. The likelihood calculator 81 outputs the generated fourth four-parameter data to the multiplication module 82.

Upon receipt of sixth four-parameter data (to be described later) from the likelihood calculator 81, the estimation module 83 assumes that a target is present in all the elements of the sixth four-parameter data. The estimation module 83 estimates a range bin where the target would be present at the time of the next scan on the basis of the relative velocity, which is a parameter of the sixth four-parameter data. Namely, when a target is present in range bin r, frequency bin m at the time of the i^{th} scan, the estimation module 83 estimates the target to be present in range bin r+Δn, frequency bin m at the time of the (i+1)^{th} scan, which is performed T_{scan} later. The estimation module 83 shifts the sixth four-parameter data to the estimated range bin, and generates fifth four-parameter data. The estimation module 83 causes the memory 54 to store the generated fifth four-parameter data.

Upon receipt of fourth four-parameter data from the likelihood calculator 81, the multiplication module 82 reads the fifth four-parameter data generated based on the previous scan from the memory 54. The multiplication module 82 multiplies the likelihood information of the fourth four-parameter data supplied from the likelihood calculator 81 by the likelihood information of the fifth four-parameter data read from the memory 54 to generate sixth four-parameter data.

In the case of first scan, the multiplication module 82 may output the fourth four-parameter data supplied from the likelihood calculator 81 to the estimation module 83 as sixth four-parameter data. Further, in the case of first scan, the likelihood calculator 81 may output the fourth four-parameter data to the estimation module 83. In this case, the estimation module 83 generates fifth four-parameter data based on the fourth four-parameter data output from the likelihood calculator 81, and causes the memory 54 to store the generated fifth four-parameter data.

The radar equipment may further comprise a target detector in the stage subsequent to the multiplication processor 80. The target detector determines whether the likelihood information of the sixth four-parameter data supplied from the multiplication module 82 falls below a predetermined error-alarm probability. If the likelihood information of the sixth four-parameter data falls below the error-alarm probability, the target detector determines that a target has been detected.

As described above, in Example 1 of the second embodiment, the likelihood calculator 81 calculates likelihood information based on the distribution of amplitude values indicated by first four-parameter data. The likelihood calculator 81 converts the amplitude value indicated by the first four-parameter data into calculated likelihood information to generate fourth four-parameter data. The multiplication module 82 multiplies likelihood information of the fourth four-parameter data supplied from the likelihood calculator 81 with likelihood information of fifth four-parameter data estimated based on the previous scan result to generate sixth four-parameter data. The radar equipment then detects a target using likelihood information indicated by the generated sixth four-parameter data. In the radar device in Example 1 of the first embodiment, the integration module 52 adds a power (or amplitude value) every scan, and the synthesis value linearly increases. Therefore, the dynamic range needs to be wide. In contrast, the radar device in Example 2 of the second embodiment multiplies two likelihood information pieces together, and probabilistically detects a target using likelihood information obtained by the multiplication. Therefore, increase in the necessary dynamic range can be prevented.

Moreover, in Example 1 of the second embodiment, the analog-to-digital converter 14 digitizes a received pulse with a sampling frequency higher than that for generation of a pulse compression coefficient at the pulse compressor 30. Therefore, the number of samples in the range resolution increases by the number of samples obtained by oversampling, although the range resolution remains the same as that in the case where oversampling is not used. Therefore, target signal components spread over a plurality of range bins. Consequently, even when there is an error between the estimated number of range bins and the actual number of range bins, the likelihood information of the fifth four-parameter data read from the memory 54 is multiplied by the likelihood information of the fourth four-parameter data supplied from the likelihood calculator 81 in at least one range bin. Accordingly, the influence of the error between the estimated number of range bins and the actual number of range bins exerted on multiplication processing can be mitigated.

### Example 2

FIG. 19 is a block diagram showing a functional configuration of the multiplication processor 80 of the radar equipment in Example 2 of the second embodiment. In Example 2, a plurality of radar equipments are provided as shown in FIG. 14 of the first embodiment. Each radar equipment receives pulse signals, which are transmitted from transmitters TX1-TXR as transmission pulses and, for example, reflected by a target. The transmission pulses transmitted from the transmitters TX1-TXR are pulses modulated to be uncorrelated to each other. The radar equipments share the origin and orthogonal axes of coordinates. The multiplication processor 80 shown in FIG. 19 comprises a signal processor 55 and a likelihood information calculator 84.

The likelihood information calculator 84 compares the distribution of amplitude values indicated by six-parameter cell data supplied from the signal processor 55 with a probability density distribution of radar equipment noise stored in advance so as to calculate, as likelihood information, a probability that the received pulse referred to when the six-parameter data is generated is a noise signal of the radar equipment. The likelihood information calculator 84 generates six-parameter likelihood data by converting the amplitude value indicated by six-parameter data into the calculated likelihood information.

The transmitters TX1-TXR direct a transmission beam to a target at different times. Therefore, the pulse signals corresponding to the transmission pulses transmitted from the transmitters TX1-TXR are received by a radar equipment at different times. Further, since the transmitters TX1-TXR direct a transmission beam to a target at different times, the target may move between the times. Therefore, the likelihood information calculator 84 predetermines a movement model of a target, and estimates a degree of movement of the target from the time when one transmitter directs a transmission beam to the target to the time when another transmitter directs a transmission beam to the target, based on the predetermined movement model.

Based on the difference between pulse signal receipt times and predetermined movement model, the likelihood information calculator 84 estimates six-parameter likelihood data of a later reception time from six-parameter likelihood data obtained based on a pulse signal received earlier. The likelihood information calculator 84 multiplies likelihood information of the six-parameter likelihood data obtained based on the pulse signal received later by likelihood information of the estimated six-parameter likelihood data. Accordingly, the receipt times of the pulse signals, which are transmitted from the transmitters TX1-TXR as transmission pulses and reflected by the same target, are different from each other, but the likelihood information calculator 84 can multiply likelihood information pieces of six-parameter likelihood data items of different transmission sources together. The likelihood information calculator 84 outputs the likelihood information obtained by the multiplication to the processing server 60.

The processing server 60 multiplies likelihood information items obtained at the connected radar equipments together. The processing server 60 determines whether the likelihood information obtained by multiplication falls below a predetermined error-alarm probability. If the likelihood information falls below the error-alarm probability, the processing server 60 determines that a target is present.

In Example 2 of the second embodiment, the analog-to-digital converter 14 digitizes a received pulse with a sampling frequency higher than that for generation of a pulse compression coefficient at the pulse compressor 30. Therefore, the number of samples increases, and target signal components spread over a plurality of range bins. Consequently, even if there is an error between the actual degree of movement of a target and the degree of movement estimated according to a movement model, the likelihood information of the estimated six-parameter likelihood data is multiplied by the likelihood information of the six-parameter likelihood data based on the pulse signal received later in at least one range bin.

Therefore, the influence of the error between the actual degree of movement of a target and the degree of movement estimated according to a movement model exerted on multiplication processing can be mitigated.

Consequently, the radar equipment according to the second embodiment can effectively multiply likelihood information pieces together for each range bin.

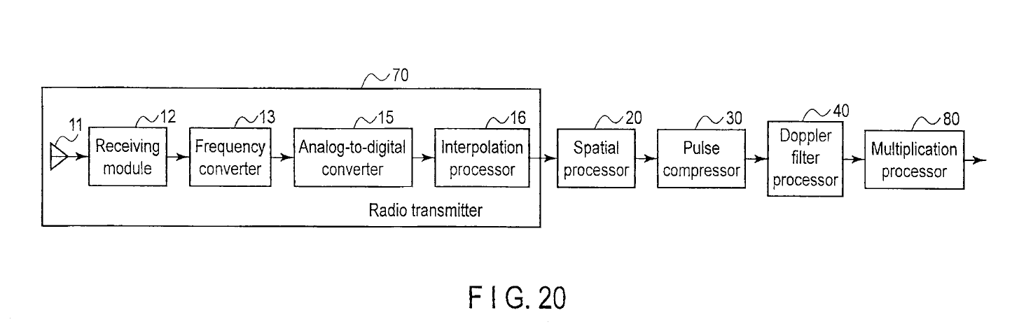

The configuration of the radar equipment of the second embodiment is not limited to the one shown in FIG. 17. For example, the radar equipment may have the functional configuration shown in FIG. 20. The radar equipment shown in FIG. 20 comprises a radio transmitter 70, a spatial processor 20, a pulse compressor 30, a Doppler filter processor 40 and a multiplication processor 80.

The analog-to-digital converter 15 digitizes a received pulse supplied from the frequency converter 13 by using oversampling. The interpolation processor 16 performs pseudo-sampling on the digitized data. Therefore, the number of samples in the range resolution increases by the number of samples obtained by oversampling and the number of samples obtained by pseudo-sampling although the range resolution remains the same as that in the case where neither oversampling nor pseudo-sampling is used. Consequently, even if there is an error between the actual degree of movement of a target and the degree of movement estimated according to a movement model, likelihood information pieces are effectively multiplied together in at least one range bin. Accordingly, the influence of the error between the actual degree of movement of a target and the degree of movement estimated according to a movement model exerted on multiplication processing can be mitigated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radar equipment, comprising:
a radio transmitter configured to receive pulse signals and digitize the received pulse signals by oversampling with a frequency higher than that for generation of a pulse compression coefficient to generate digital data;
a pulse compressor configured to perform pulse compression on the digital data using the pulse compression coefficient to generate range bin data with an increased number of samples for each of the pulse signals;
a Doppler filter processor configured to perform Doppler filter processing on the range bin data to generate range bin data with an increased number of samples for each frequency bin;
an integration processor configured to integrate the range bin data subjected to the Doppler filter processing for each range bin.

2. The radar equipment of claim 1, wherein
the radio transmitter further performs interpolation processing to generate pseudo-sampling points between adjacent sampling points of the digital data, and
the pulse compressor performs pulse compression on the digital data subjected to the interpolation processing to generate range bin data with a further increased number of samples for each of the pulse signals.

3. The radar equipment of claim 1, wherein the integration processor comprises:
a signal processor configured to generate first four-parameter data indicating a state of a predetermined search area using a range, an azimuth angle, an elevation angle, and a relative velocity calculated based on the frequency bin, based on the range bin data for each frequency bin obtained by one scan to the search area;
an integration module configured to generate third four-parameter data by integrating the first four-parameter data generated at the signal processor with second four-parameter data generated based on first four-parameter data obtained by a previous scan to the search area; and
an estimation module configured to estimate a position at a time of a next scan based on a relative velocity indicated by the third four-parameter data and shift the third four-parameter data to the estimated position to generate second four-parameter data.

4. The radar equipment of claim 1, wherein
the pulse signals are a plurality of transmission pulses modulated to be uncorrelated to one another and reflected, scattered or diffracted,
the integration processor comprises:
a signal processor configured to generate six-parameter data indicating a state of a predetermined search area using coordinates in a Cartesian coordinate system with a preset origin and orthogonal axes, and velocity components of a target in the Cartesian coordinate system, based on the range bin data for each frequency bin; and
an integration module configured to estimate six-parameter data of a later receipt time from six-parameter data obtained based on a pulse signal received earlier based on a difference between receipt times, and integrate six-parameter data obtained based on a pulse signal received later with the estimated six-parameter data.

5. A radar equipment, comprising:
a radio transmitter configured to receive pulse signals and digitize the received pulse signals by oversampling with a frequency higher than that for generation of a pulse compression coefficient to generate digital data;
a pulse compressor configured to perform pulse compression on the digital data using the pulse compression coefficient to generate range bin data with an increased number of samples for each of the pulse signals;
a Doppler filter processor configured to perform Doppler filter processing on the range bin data to generate range bin data with an increased number of samples for each frequency bin;
a multiplication processor configured to calculate likelihood information based on the range bin data subjected to the Doppler filter processing, and multiply the likelihood information for each range bin.

6. The radar equipment of claim 5, wherein
the radio transmitter further performs interpolation processing on adjacent digital data items of the digital data to generate pseudo-sampling points, and
the pulse compressor performs the pulse compression on the digital data subjected to the interpolation processing to generate range bin data with a further increased number of samples for each of the pulse signals.

7. The radar equipment of claim 5, wherein the multiplication processor further comprises:
a signal processor configured to generate first four-parameter data indicating a state of a predetermined search area using a range, an azimuth angle, an elevation angle, and a relative velocity calculated based on the frequency bin, based on the range bin data for each frequency bin obtained by one scan to the search area;
a likelihood calculator configured to calculate likelihood information indicating a probability that the first four-parameter data is derived from noise, and generate second four-parameter data indicating the first four-parameter data by the calculated likelihood information;
a multiplication processor configured to multiply the second four-parameter data by third four-parameter data generated based on second four-parameter data obtained by a previous scan to the search area to generate fourth four-parameter data; and
an estimation module configured to estimate a position at a time of a next scan based on a relative velocity indicated by the fourth four-parameter data and shift the fourth four-parameter data to the estimated position to generate third four-parameter data.

8. The radar equipment of claim 5, wherein
the pulse signals are a plurality of transmission pulses modulated to be uncorrelated to one another and reflected, scattered or diffracted,
the multiplication processor comprises:
a signal processor configured to generate six-parameter data indicating a state of a predetermined search area using coordinates in a Cartesian coordinate system with a preset origin and orthogonal axes, and velocity components of a target in the Cartesian coordinate system, based on the range bin data for each frequency bin; and
a likelihood information calculator configured to: calculate likelihood information indicating a probability that the six-parameter data is derived from noise, and generate six-parameter likelihood data indicating the six-parameter data by the calculated likelihood information; estimate six-parameter likelihood data of a later receipt time from six-parameter likelihood data obtained based on a pulse signal received earlier based on a difference between receipt times; and multiply six-parameter likelihood data obtained based on a pulse signal received later by the estimated six-parameter likelihood data.

9. A received data processing method, comprising:
receiving pulse signals;
digitizing the received pulse signals by oversampling with a frequency higher than that for generation of a pulse compression coefficient to generate digital data;
performing pulse compression on the digital data using the pulse compression coefficient to generate range bin data with an increased number of samples for each of the pulse signals;
performing Doppler filter processing on the range bin data to generate range bin data with an increased number of samples for each frequency bin; and
integrating the range bin data subjected to the Doppler filter processing for each range bin.

10. The received data processing method of claim 9, further comprising:
performing interpolation processing to generate pseudo-sampling points between adjacent sampling points of the digital data; and
performing the pulse compression on the digital data subjected to the interpolation processing to generate range bin data with a further increased number of samples for each of the pulse signals.

11. A received data processing method, comprising:
receiving pulse signals;
digitizing the received pulse signals by oversampling with a frequency higher than that for generation of a pulse compression coefficient to generate digital data;
performing pulse compression on the digital data using the pulse compression coefficient to generate range bin data with an increased number of samples for each of the pulse signal;
performing Doppler filter processing on the range bin data to generate range bin data with an increased number of samples for each frequency bin; and
calculating likelihood information based on the range bin data subjected to the Doppler filter processing, and multiplying the likelihood information for each range bin.

12. The received data processing method of claim 11, further comprising:
performing interpolation processing on adjacent sampling points of the digital data to generate pseudo-sampling points, and
performing the pulse compression on the digital data subjected to the interpolation processing to generate range bin data with a further increased number of samples for each of the pulse signals.
